(19) United States
(12) Patent Application Publication
(10) Pub. No.: US 2010/0298960 A1
(43) Pub. Date: Nov. 25, 2010

(54) METHOD AND APPARATUS FOR GENERATING AUDIO, AND METHOD AND APPARATUS FOR REPRODUCING AUDIO

(75) Inventors: Choong Sang Cho, Gyeonggi-do (KR); Je Woo Kim, Gyeonggi-do (KR); Byeong Ho Choi, Gyeonggi-do (KR)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: KOREA ELECTRONICS TECHNOLOGY INSTITUTE, Gyeonggi-do (KR)

(21) Appl. No.: 12/760,154

(22) Filed: Apr. 14, 2010

(30) Foreign Application Priority Data
May 20, 2009 (KR) 1020090044162

(51) Int. Cl. G06F 17/00

(52) U.S. Cl. 700/94

(57) ABSTRACT

An audio generating method, an audio generating apparatus, an audio reproducing method, and an audio reproducing apparatus are provided. The audio generating method includes generating description information which comprises at least one scene effect containing an audio effect to collectively apply to all of audio objects; and generating an audio bitstream by combining the description information and the audio objects.

### PRIORITY

This application claims the benefit under 35 U.S.C. §119(a) to a Korean patent application filed in the Korean Intellectual Property Office on May 20, 2009 and assigned Serial No. 10-2009-0044162, the entire disclosure of which is hereby incorporated by reference.

### BACKGROUND OF THE INVENTION

1. Field of the Invention

The present invention relates generally to an audio processing. More particularly, the present invention relates to a method and an apparatus for generating audio, and a method and an apparatus for reproducing the audio.

2. Description of the Related Art

In general, audio services provided through radio, MP3, and CD synthesize a signal acquired from two or tens of sound sources according to the sound source, store and reproduce as a mono, stereo, and 5.1 channel signal.

Interaction of a user with the given sound source in such a service can regulate a sound volume, amplify and attenuate the band through an equalizer, but cannot control and affect a particular object with respect to the given sound source.

To overcome this shortcoming, in the production of audio contents, objects required for the synthesis and information corresponding to the effect and the sound volume for the objects are stored so that the user can synthesize them, which is referred to as an object-based audio service, rather than synthesizing signals corresponding to the sound sources by a service provider.

The object-based audio service includes compression information of each object and scene description information required to synthesize the objects. The compression information of the object can adopt an audio codec such as MPEG-1 Layer 3 (MP3), Advanced Audio Coding (AAC), and MPEG-4 Audio Lossless Coding (ALS), and the scene description information can use MPEG-4 Binary Format for Scenes (BIFs) and MPEG-4 Lightweight Application Scene Representation (LASeR).

The BIFs specifies a binary format for synthesizing, storing, and reproducing two- or three-dimensional audiovisual content, and animates a program and a content database through the BIFs. For example, the BIFs describes which subtitles is inserted to a scene, which format is applied to the image, and how often and how long the image is represented. For a specific scene, the user can interact with the rendered object through the BIFs by defining and processing an event for the interaction. As for the audio, a sound source localization effect and a reverberation effect are defined.

The LASeR is a rich-media content standard dedicated to a mobile environment and defined in MPEG-4 part 20. The LASeR aims for the light weight to be applied to resource-constraint mobile terminals, and is compatible with W3C and SVG widely used in the mobile environment to represent the graphic animation. The LASeR standard includes a LASeR Markup Language (ML) for composing the scene, a binary standard for the efficient transmission, and a Simple Aggregation Format (SAF) for synchronization and transmission of media decoding information.

Drawbacks of the BIFs and the LASeR are discussed. The BIFs limits a function defined for the three-dimensional sound effect to the sound image localization effect and the reverberation effect. Since the BIFs requires considerable computations, it is difficult to implement in mobile devices. By contrast, as the LASeR requires low computations and is encoded in the binary format, it is suitable for the mobile devices. Disadvantageously, having no function defined for the audio processing, the LASeR cannot provide the three-dimensional effect and various synthesis effects.

Thus, it is necessary to develop a scene description method for actively reflecting user's demands and efficiently providing the latest high-quality and 3D audio effects by applying to various platforms.

### SUMMARY OF THE INVENTION

An aspect of the present invention is to address at least the above mentioned problems and/or disadvantages and to provide at least the advantages described below. Accordingly, an aspect of the present invention is to provide a method and an apparatus for generating and reproducing audio using description information including at least one scene effect containing an audio effect to be applied collectively to every audio object.

Another aspect of the present invention is to provide a method and an apparatus for generating and reproducing audio using description information including object descriptions each containing information relating to play intervals with respect to audio objects.

According to one aspect of the present invention, an audio generating method includes generating description information which includes at least one scene effect containing an audio effect to collectively apply to all of audio objects; and generating an audio bitstream by combining the description information and the audio objects.

The scene effect may include information indicating an application start time of the audio effect to collectively apply, an application end time of the audio effect to collectively apply, and the audio effect to collectively apply.

The description information may further include object descriptions containing audio effects to apply to the audio objects individually.

The object description may include information indicating an application start time of the audio effect to individually apply, an application end time of the audio effect to individually apply, and the audio effect to individually apply.

The description information may further include object descriptions each containing information relating to play intervals of the audio objects respectively.

The play interval may include a first play interval for the audio object, and a second play start interval apart from the first play interval, and the play interval may be defined to reproduce the audio object by segmenting on the time basis.

The audio object may not be reproduced between the first play interval and the second play interval.

The at least one audio effect may be determined by an audio editor.

The description information may contain an ID to distinguish from other description information.

According to another aspect of the present invention, an audio generating apparatus includes an encoder for generating description information which includes at least one scene effect containing an audio effect to collectively apply to all of audio objects; and a packetizer for generating an audio bitstream by combining the description information and the audio objects.

The scene effect may include information indicating an application start time of the audio effect to collectively apply, an application end time of the audio effect to collectively apply, and the audio effect to collectively apply.

The description information may further include object descriptions containing audio effects to apply to the audio objects individually.

The object description may include information indicating an application start time of the audio effect to individually apply, an application end time of the audio effect to individually apply, and the audio effect to individually apply.

The description information may further include object descriptions each containing information relating to play intervals of the audio objects respectively.

The play interval may include a first play interval for the audio object, and a second play start interval apart from the first play interval, and the play interval may be defined to reproduce the audio object by segmenting on the time basis.

The audio object may not be reproduced between the first play interval and the second play interval.

The at least one audio effect may be determined by an audio editor.

The description information may contain an ID to distinguish from other description information.

According to yet another aspect of the present invention, an audio reproducing method includes separating description information and audio objects in an audio bitstream; decompressing the audio objects; and processing audio to collectively apply an audio effect contained in a scene effect of the description information to all of the decompressed audio objects.

The processing of the audio may include generating one audio signal by combining the decompressed audio objects; and collectively applying the audio effect to all of the decompressed audio objects by applying the audio effect to the audio signal.

The processing of the audio may further include before generating the audio signal, applying audio effects to the decompressed audio objects individually by referring to the audio effects contained in object descriptions of the description information.

The generating of the audio signal may generate the one audio signal by synthesizing the decompressed audio objects based on play intervals for the decompressed audio objects in the object descriptions of the description information.

The play interval may include a first play interval for the audio object, and a second play start interval apart from the first play interval, and the generating of the audio signal may synthesize the decompressed audio objects to split and reproduce the audio object on the time basis.

The generating of the audio signal may synthesize the decompressed audio objects not to reproduce the audio object between the first play interval and the second play interval.

The processing of the audio may apply the audio effect to all or some of the decompressed audio objects based on edit of a user.

The description information may contain an ID to distinguish from other description information.

According to still another aspect of the present invention, an audio reproducing apparatus includes a depacketizer for separating description information and audio objects in an audio bitstream; an audio decoder for decompressing the audio objects; and an audio processor for collectively applying an audio effect contained in a scene effect of the description information to all of the decompressed audio objects.

The audio processor may generate one audio signal by combining the decompressed audio object, and collectively apply the audio effect to all of the decompressed audio objects by applying the audio effect to the audio signal.

The audio processor, before generating the audio signal, may apply audio effects to the decompressed audio objects individually by referring to the audio effects contained in object descriptions of the description information.

The audio processor may generate the one audio signal by synthesizing the decompressed audio objects based on play intervals for the decompressed audio objects contained in the object descriptions of the description information.

The play interval may include a first play interval for the audio object, and a second play start interval apart from the first play interval, and the audio processor may synthesize the decompressed audio objects to split and reproduce the audio object on the time basis.

The audio processor may synthesize the decompressed audio objects not to reproduce the audio object between the first play interval and the second play interval.

The audio processor may apply the audio effect to all or some of the decompressed audio objects based on edit of a user.

The description information may contain an ID to distinguish from other description information.

According to a further aspect of the present invention, an audio generating method includes generating description information which includes object descriptions each containing information relating to play intervals for audio objects; and generating an audio bitstream by combining the description information and the audio objects.

The play interval may include a first play interval for the audio object, and a second play start interval apart from the first play interval, and the play interval may be defined to reproduce the audio object by segmenting on the time basis.

The audio object may not be reproduced between the first play interval and the second play interval.

The description information may contain an ID to distinguish from other description information.

According to a further aspect of the present invention, an audio generating apparatus includes an encoder for generating description information which includes object descriptions each containing information relating to play intervals for audio objects; and a packetizer for generating an audio bitstream by combining the description information and the audio objects.

The play interval may include a first play interval for the audio object, and a second play start interval apart from the first play interval, and the play interval may be defined to reproduce the audio object by segmenting on the time basis.

The audio object may not be reproduced between the first play interval and the second play interval.

The description information may contain an ID to distinguish from other description information.

According to a further aspect of the present invention, an audio reproducing method includes separating description information and audio objects in an audio bitstream; decompressing the audio objects; and generating one audio signal by synthesizing the decompressed audio objects based on play intervals with respect to the decompressed audio objects contained in object descriptions of the description information.

The play interval may include a first play interval for the audio object, and a second play start interval apart from the first play interval, and the generating of the audio signal may synthesize the decompressed audio objects to split and reproduce the audio object on the time basis.

The generating of the audio signal may synthesize the decompressed audio objects not to reproduce the audio object between the first play interval and the second play interval.

The description information may contain an ID to distinguish from other description information.

According to a further aspect of the present invention, an audio reproducing apparatus includes a depacketizer for separating description information and audio objects in an audio bitstream; an audio decoder for decompressing the audio objects; and an audio processor for generating one audio signal by synthesizing the decompressed audio objects based on play intervals with respect to the decompressed audio objects contained in object descriptions of the description information.

The play interval may include a first play interval for the audio object, and a second play start interval apart from the first play interval, and the audio processor may synthesize the decompressed audio objects to split and reproduce the audio object on the time basis.

The audio processor may synthesize the decompressed audio objects not to reproduce the audio object between the first play interval and the second play interval.

The description information may contain an ID to distinguish from other description information.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments the present invention will become more apparent from the following detailed description taken in conjunction with the accompanying drawings, in which:

FIG. 1 is a block diagram of an audio generating apparatus according to an exemplary embodiment of the present invention;

FIG. 2 is a flowchart of a method for generating an audio bitstream at the audio generating apparatus of FIG. 1;

FIG. 3 is a block diagram of an audio reproducing apparatus according to another exemplary embodiment of the present invention;

FIG. 4 is a flowchart of a method for reproducing the audio bitstream at the audio reproducing apparatus of FIG. 3;

FIG. 5 is a diagram of a data structure of description information;

FIG. 6 is a diagram of a data structure of detailed information for sound image localization effect;

FIG. 7 is a diagram of a data structure of detailed information for virtual space effect;

FIG. 8 is a diagram of a data structure of detailed information for externalization effect;

FIG. 9 is a diagram of a background sound index field (mBG_index) as detailed information for background sound effect; and

FIG. 10 is a diagram of audio object selection and addition in audio content.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

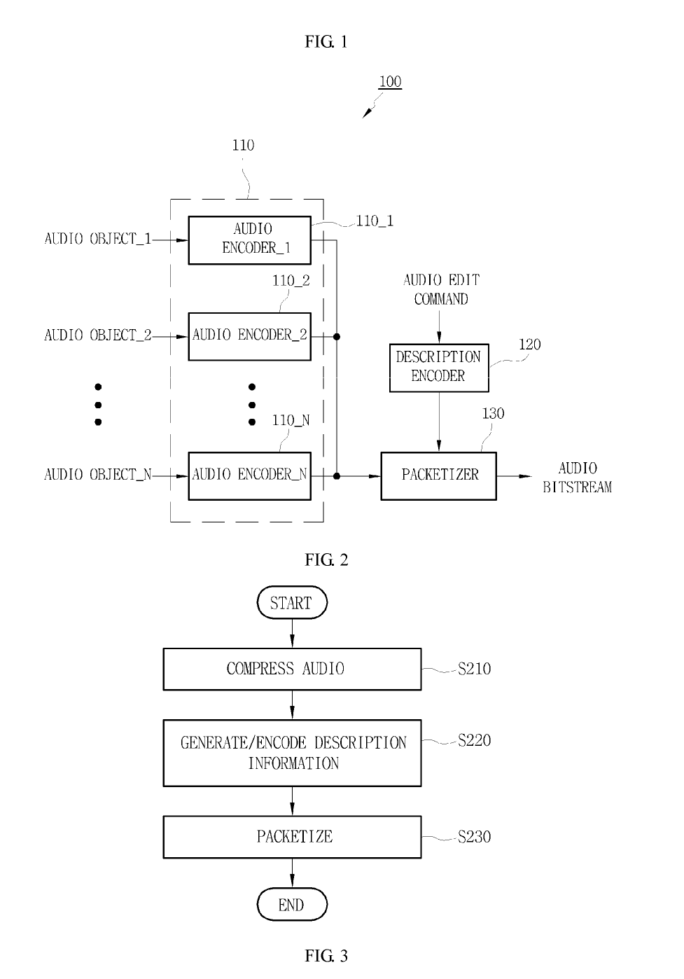

FIG. 1 is a block diagram of an audio generating apparatus according to an exemplary embodiment of the present invention. The audio generating apparatus 100 generates an audio bitstream including description information relating to audio objects.

The description information is divided to Scene Effect Information (SEI) relating to all of the audio objects, and Object Description Information (ODI) relating to each individual audio object.

The SEI is information relating to the audio effects collectively applied to all of the audio objects in the audio bitstream.

The ODI is information relating the audio effects individually applied to the audio objects in the audio bitstream and relating to a play interval.

The audio generating apparatus 100 includes an audio encoder 110, a description encoder 120, and a packetizer 130 as shown in FIG. 1.

The audio encoder 110 compresses the input audio objects. As shown in FIG. 1, the audio encoder 110 includes N-ary audio encoders 110-1 through 110-N.

The audio encoder-1 110-1 compresses the audio object-1, the audio encoder-2 110-2 compresses the audio object-2, . . . , and the audio encoder-N 110-N compresses the audio object-N.

The audio object is a component of the audio content, and the audio content includes a plurality of audio objects. Provided that the audio content is music, the audio objects can be audios produced by musical instruments used to play the music. For example, the audio object-1 is the audio produced by the guitar, the audio object-2 is the audio produced by the base, . . . , and the audio object-N is the audio produced by the drum.

The description encoder 120 generates description information according to an edit command of an audio editor, and encodes the generated description information.

The description information includes 1) the SEI including at least one scene effect containing data relating to the audio effect collectively applied to every audio object, and 2) the ODI including at least one object description containing data relating to the audio effect and the play interval individually applied to each audio object of the audio bitstream.

The scene effects are applied to all of the audio objects in the audio bitstream. The object description is generated per audio object. That is, the object description for the audio object-1, the object description for the audio object-2, . . . , and the object description for the audio object-N are generated separately.

Structures of the SEI and the ODI constituting the description information shall be described later.

The description information is generated according to the command of the audio editor. Accordingly, the audio effect in the scene effects, the audio effect and the play interval in the object descriptions are determined by the audio editor.

The packetizer 130 generates the audio bitstream by combining the compressed audio objects output from the audio encoder 110 and the description information generated at the description encoder 120. In more detail, the packetizer 130 generates the audio bitstream by arranging the audio objects in order and prefixing the description information to the audio objects.

FIG. 2 is a flowchart of a method for generating the audio bitstream at the audio generating apparatus of FIG. 1.

The audio encoder 110 compresses the input audio objects (S210). The description encoder 120 generates the description information according to the edit command of the audio editor and encodes the generated description information (S220). The packetizer 130 generates the audio bitstream by combining the audio objects compressed in S210 and the description information generated and encoded in S220.

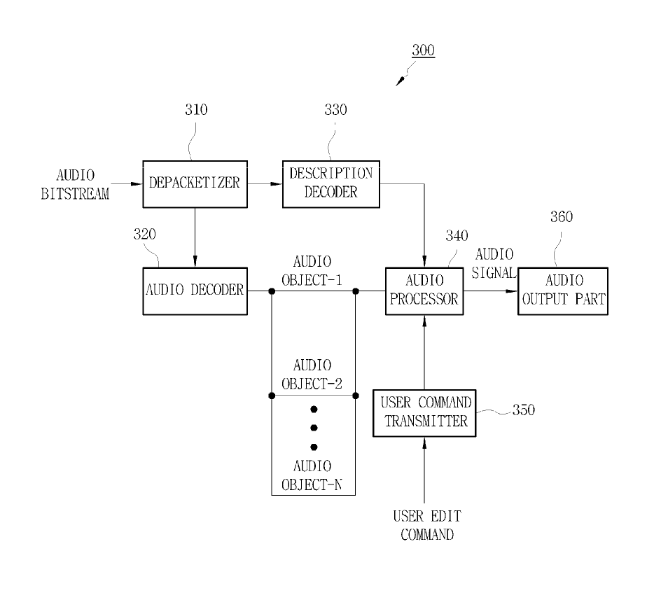

FIG. 3 is a block diagram of an audio reproducing apparatus according to another exemplary embodiment of the present invention. The audio reproducing apparatus 300 can restore and reproduce the audio signal from the object-based audio bitstream generated by the audio generating apparatus of FIG. 1.

The audio reproducing apparatus 300 includes a depacketizer 310, an audio decoder 320, a description decoder 330, an audio processor 340, a user command transmitter 350, and an audio output part 360 as shown in FIG. 3.

The depacketizer 310 receives the audio bitstream generated by the audio generating apparatus 100 and splits to the audio objects and the description information. The audio objects separated by the depacketizer 310 are applied to the audio decoder 320, and the description information separated by the depacketizer 310 is applied to the description decoder 330.

The audio decoder 320 decompresses the audio objects fed from the depacketizer 310. In result, the audio decoder 320 outputs the N-ary audio objects before compressed by the audio encoder 110.

The description decoder 330 decodes the description information generated and encoded by the description encoder 120.

The audio processor 340 generates one audio signal by synthesizing the N-ary audio objects fed from the audio decoder 320. As generating the audio signal, the audio processor 340 arranges the audio objects by referring to the description information fed from the description decoder 330 and applies the audio effect.

In detail, the audio processor 340

1) applies the audio effect individually to the corresponding audio objects by referring to the audio effect in the ODI,

2) generates one audio signal by synthesizing the audio objects based on the play intervals in the ODI, and

3) applies the audio effect to the audio signal by referring to the audio effect in the SEI,

which are explained more respectively.

1) Individually Apply the Audio Effect by Referring to the ODI

The object descriptions constituting the ODI are present respectively per audio object as stated earlier. That is, the object description-1 for the audio object-1, the object description-2 for the audio object-2, . . . , and object description-N for the audio object-N exist separately.

a) If the sound image localization effect is designated as the audio effect in the object description-1, the audio processor 340 applies the sound image localization effect to the audio object-1. b) If the virtual space effect is designated as the audio effect in the object description-2, the audio processor 340 applies the virtual space effect to the audio object-2 . . . c) If the externalization effect is designated as the audio effect in the object description-N, the audio processor 340 applies the externalization effect to the audio object-N.

While the single audio effect is contained in the object description in the above example, two or more audio effects can be contained in the object description if necessary.

2) Synthesize the Audio Objects by Referring to the ODI

The object descriptions constituting the ODI contain the information relating to the play interval of the corresponding audio object. The play interval includes a start time and an end time. Two or more play intervals can be defined for one audio object.

The audio object contains only the audio data to be reproduced in the play interval designated in the object description. For example, when the play interval designated in the object description is “0:00˜10:00” and “25:00˜30:00”, the audio object contains only the audio data to be reproduced in “0:00˜10:00” and the audio data to be reproduced in “0:00˜10:00” and “25:00˜30:00”, rather than the audio data to be reproduced in “0:00˜30:00”.

The total play time is “15:00 (10:00+5:00)” in the above audio object, the time taken to complete the play is “30:00”.

If,

a) the play interval in the object description-1 is set to “0:00˜30:00”,

b) the play interval in the object description-2 is set to “0:00˜10:00”,

. . . ,

c) the play interval in the object description-N is set to “20:00˜30:00”,

the audio processor 340 generates one audio signal by synthesizing the audio object-1, the audio object-2, . . . , the audio object-N so as to,

a) reproduce the audio object-1 and the audio object-2 in “0:00˜10:00”,

b) reproduce only the audio object-1 in “10:00˜20:00”,

. . . ,

c) reproduce the audio object-1 and the audio object-N in “20:00˜30:00”.

3) Collectively Apply the Audio Effect by Referring to the SEI

The audio effect in the scene effect of the SEI is applied to the one audio signal generated through the synthesis. Yet, the one audio signal is the combination of all of the audio objects. Accordingly, the audio effect contained in the scene effect is to be applied to every audio object.

When the background sound effect is designated as the audio effect in the scene effect, the audio processor 340 applies the background sound effect to the audio signal generated by synthesizing the audio objects.

So far, the audio processor 340 applies the audio effect to the audio objects individually, combines the audio objects, and collectively applies the audio effect to the combined audio objects.

The audio processing of the audio processor 340 mentioned above can be changed by a user of the audio reproducing apparatus 300. For example, the user of the audio reproducing apparatus 300 can give the edit command to apply a particular audio effect to all or some of the audio objects.

The user command transmitter 350 of FIG. 3 receives and forwards the user edit command to the audio processor 340. The audio processor 340 reflects the user edit instruction in the audio processing.

The audio output part 360 outputs the audio signal output from the audio processor 340 through an output element such as speaker or output port, so that the user can enjoy the audio.

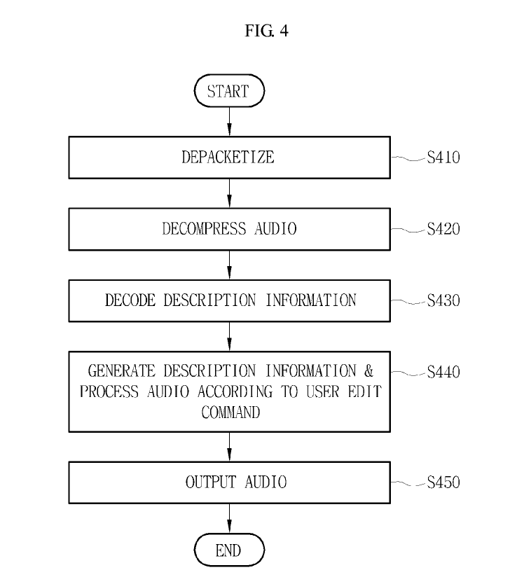

FIG. 4 is a flowchart of a method for reproducing the audio bitstream at the audio reproducing apparatus of FIG. 3.

The depacketizer 310 splits the audio bitstream to the audio objects and the description information (S410). The audio decoder 320 decompresses the audio objects separated in S410 (S420). The description decoder 330 decodes the description information separated in S410 (S430).

Next, the audio processor 340 processes the audio signal with respect to the audio objects decompressed in S420 according to the description information decoded in S430 and the user edit command input via the user command transmitter 350, and generates one audio signal (S440).

The audio output part 360 outputs the audio processed in S440 so that the user can listen to the audio (S450).

Hereafter, the detailed structures of the SEI and the ODI composing the description information are provided.

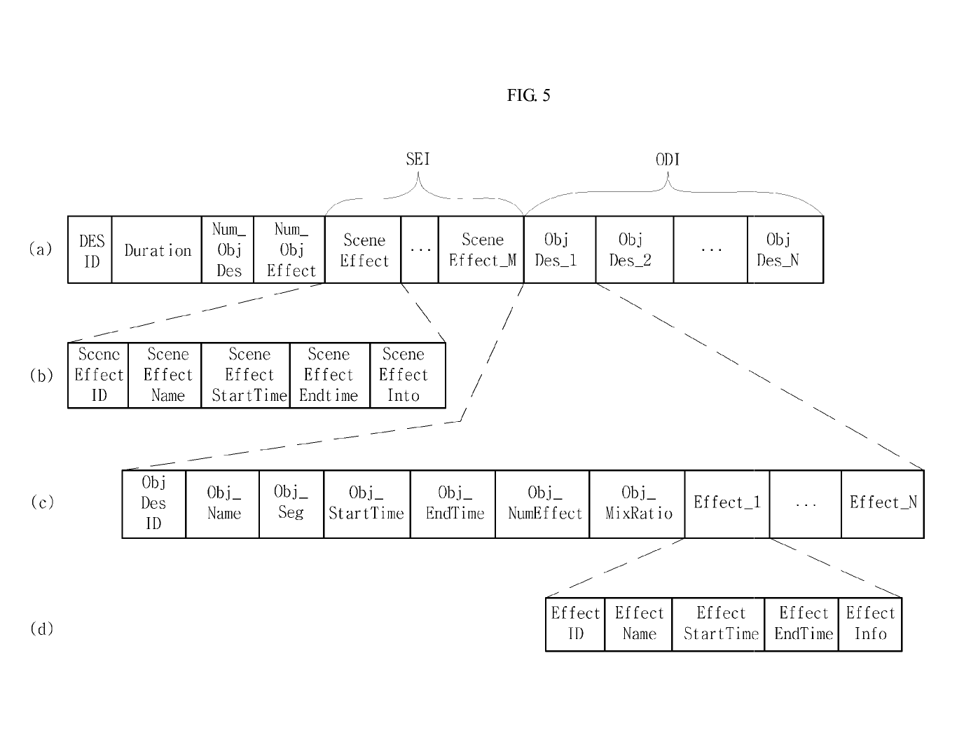

FIG. 5 is a diagram of a data structure of the description information. The audio objects following the description information in FIG. 5 correspond to the audio bitstream generated by the packetizer 130.

To ease the understanding, the audio objects are not shown and only the description information contained in the audio bitstream is depicted in FIG. 5.

As shown in FIG. 5A, the description information includes 1) a description ID field (Des ID), 2) a play time field (Duration), 3) the number of the object descriptions field (Num_ObjDes), 4) the number of the scene effects field (Num_SceneEffect), 5) the SEI, and 6) the ODI.

The description ID field (Des ID) contains ID to distinguish the description information from the other description information. When there are multiple description information, the description ID field (Des ID) is necessary.

The play time field (Duration) carries information relating to the total play time of the audio bitstream.

The number of the object descriptions field (Num_ObjDes) contains information relating to the number of the object descriptions in the description information. The number of the scene effects field (Num_SceneEffect) contains information relating to the number of the scene effects in the description information.

The SEI includes M-ary scene effect fields (SceneEffect_1, . . . , SceneEffect_M).

As shown in FIG. 5B, the first scene effect field (SceneEffect_1) includes 1) a scene effect ID field (SceneEffect_ID), 2) a scene effect name field (SceneEffect_Name), 3) a scene effect start time field (SceneEffect_StartTime), 4) a scene effect end time field (SceneEffect_EndTime), and 5) a scene effect information field (SceneEffect_Info).

The data structures of the second scene effect field (SceneEffect_2) through the M-th scene effect field (SceneEffect_M) are the same as the first Scene effect field (SceneEffect_1). Hereafter, the data structure of the first scene effect field (SceneEffect_1) is described alone.

The scene effect ID field (SceneEffect_ID) contains the ID to distinguish the first scene effect field (SceneEffect_1) from the other scene effect fields.

The scene effect name field (SceneEffect_Name) contains the name of the audio effect to apply through the first scene effect field (SceneEffect_1). For example, when the audio effect to apply through the first scene effect field (SceneEffect_1) is the reverberation, “reverberation” is contained in the scene effect name field (SceneEffect_Name).

The scene effect start time field (SceneEffect_StartTime) contains information relating to the play time when the scene effect application starts. The scene effect end time field (SceneEffect_EndTime) contains information relating to the play time when the scene effect application ends.

The scene effect information field (SceneEffect_Info) contains detailed information required to apply the audio effect.

The scene effect information field (SceneEffect_Info) can contain the detailed information relating to 1) the sound image localization effect, 2) the virtual space effect, 3) the externalization effect), or 4) the background sound effect as the audio effect. The data structures of these audio effects will be explained.

Meanwhile, as shown in FIG. 5A, the ODI includes the N-ary object description fields (ObjDes_1, ObjDes_2, . . . , ObjDes_N). The number of the object description fields (ObjDes_1, ObjDes_2, . . . , ObjDes_N) in the ODI is equal to the number of the audio objects in the audio bitstream. This is because the object description is individually generated per audio object.

The first object description field (ObjDes_1) contains the description information relating to the audio object-1, the second object description field (ObjDes_2) contains the description information relating to the audio object-2, . . . , and the N-th object description field (ObjDes_N) contains the description information relating to the audio object-N.

In FIG. 5C, the first object description field (ObjDes_1) includes 1) an object description ID field (ObjDes_ID), 2) an object name field (Obj_Name), 3) an object segment field (Obj_Seg), 4), an object start time field (Obj_StartTime), 5) an object end time field (Obj_EndTime), 6) an object effect number field (Obj_NumEffect), 7) an object mix ratio field (Obj_MixRatio), and 8) effect fields (Effect_1, . . . , Effect_L).

The data structures of the second object description field (ObjDes_2) through the N-th object description field (ObjDes_N) are the same as the first object description field (ObjDes_1). Hereafter, the data structure of the first object description field (ObjDes_1) is provided alone.

The object description ID field (ObjDes ID) contains ID to distinguish the object description field from the other object description fields.

The object name field (Obj_Name) contains the name of the object. For example, when the audio object-1 is the audio produced by the guitar, the object name field (Obj_Name) contains information indicating “guitar”.

The object segment field (Obj_Seg) contains information relating to how many segments the audio object is split to and then reproduced. In other words, the object segment field (Obj_Seg) contains the number of the play intervals as mentioned above.

1) The object segment field (Obj_Seg) set to “1” implies that the audio object-1 is continuously reproduced without segmentation. 2) The object segment field (Obj_Seg) set to “2” implies that the audio object-1 is segmented to two play intervals and then reproduced.

The object start time field (Obj_StartTime) and the object end time field (Obj_EndTime) contain information relating to the play interval. The number of the pairs of the object start time field (Obj_StartTime) and the object end time field (Obj_EndTime) is equal to the number of the object segment fields (Obj_Seg) (the number of the play intervals).

For example, when the play interval for the audio object-1 is “0:00 ˜10:00” and “25:00˜30:00”, 1) the first object start time field (Obj_StartTime) contains “0:00”, 2) the first object end time field (Obj_EndTime) contains “10:00”, 3) the second object start time field (Obj_StartTime) contains “25:00”, and 4) the second object end time field (Obj_EndTime) contains “30:00”.

The object effect number field (Obj_NumEffect) contains the number of the effect fields (Effect_1, . . . , Effect_L) in the object description field.

The object mix ratio field (Obj_MixRatio) contains information relating to the type of the speaker to be used when the audio object-1 is reproduced. For example, in the 5.1 channel speaker environment, when the audio object-1 is output only from the center speaker and the left front speaker, the object mix ratio field (Obj_MixRatio) contains “1, 0, 1, 0, 0, 0”.

The effect fields (Effect_1, . . . , Effect_L) each contain information of the audio effects to apply to the audio object-1.

In FIG. 5D, the first effect field (Effect_1) includes 1) an effect ID field (Effect_ID), 2) an effect name field (Effect_Name), 3) an effect start time field (Effect_StartTime), 4) an effect end time field (Effect_EndTime), and 5) an effect information field (Effect_Info).

Since the data structures of the second effect field (Effect_2) through the L-th effect field (Effect_L) are the same as the first effect field (Effect_1), the data structure of the first effect field (Effect_1) alone is provided hereinafter.

The effect ID field (Effect_ID) contains the ID to distinguish the first effect field (Effect_1) from the other effect fields.

The effect name field (Effect_Name) contains the name of the effect to apply through the first effect field (Effect_1). For example, when the effect to apply through the first effect field (Effect_1) is the reverberation, the effect name field (Effect_Name) contains “reverberation”.

The effect start time field (Effect_StartTime) contains information of the play time when the effect commences, and the effect end time field (Effect_EndTime) contains information of the play time when the effect ends.

The effect information field (Effect_Info) contains detailed information required to apply the audio effect.

The effect information field (Effect_Info) can contain the detailed information relating to 1) the sound image localization effect, 2) the virtual space effect, 3) the externalization effect, or 4) the background sound effect as the audio effect. Now, the data structure of each audio effect is elucidated.

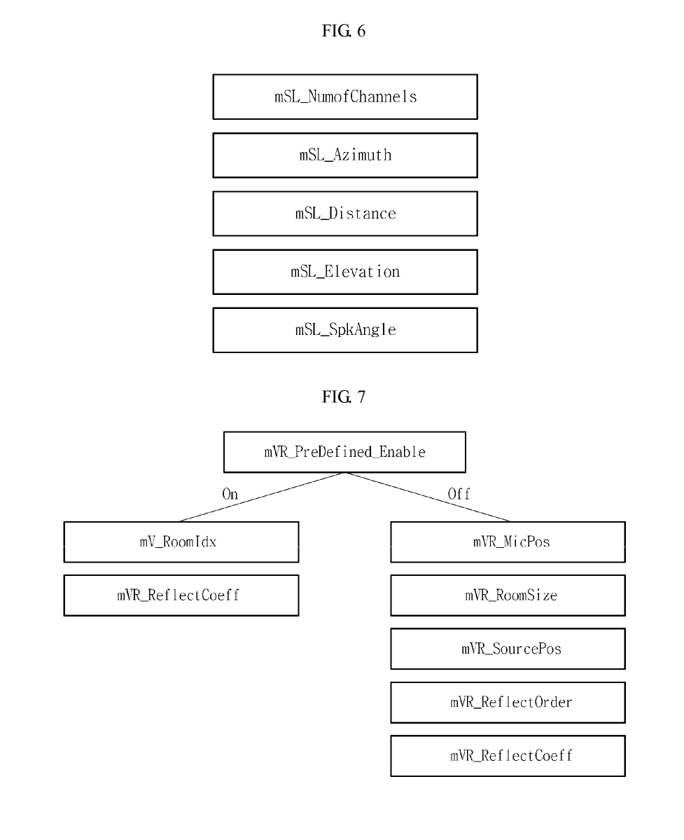

FIG. 6 depicts the data structure of the detailed information for the sound image localization effect. The sound image localization effect of FIG. 6 includes 1) a sound source channel number field (mSL_NumofChannels), 2) a sound image localization azimuth field (mSL_Azimuth), 3) a sound image localization distance field (mSL_Distance), 4) a sound image localization elevation field (mSL_Elevation), and 5) a speaker virtual angle field (mSL_SpkAngle), which are required to give senses of the direction and the distance to the audio object-1.

FIG. 7 depicts the data structure of the detailed information for the virtual space effect. The data structure of the detailed information for the virtual space effect varies depending on whether a predefined space is applied (mVR_Predefined Enable).

When the predefined space is applied, the detailed information for the virtual space effect includes 1) a field as to whether the predefined space is applied with “On” (mVR_Predefined Enable), 2) a space index field (mVR_RoomIdx), and 3) a reflection tone coefficient field (mVR_ReflectCoeff).

When the predefined space is not applied, the detailed information for the virtual space effect includes 1) the field as to whether the predefined space is applied with “Off” (mVR_Predefined Enable), 2) a microphone coordinate field (mVR_MicPos), 3) a space size field (mVR_RoomSize), 4) a sound source location field (mVR_SourcePos), 5) a reflection tone order field (mVR_ReflectOrder), and 6) the reflection tone coefficient field (mVR_ReflectCoeff) which are required to define the virtual space.

Using the detailed information for the virtual space effect, the reverberation in the virtual space can be added to the audio object-1.

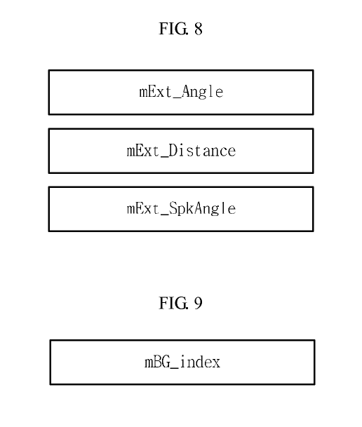

FIG. 8 depicts the data structure of the detailed information for the externalization effect. The externalization effect includes 1) an externalization angle field (mExt_Angle), 20 an externalization distance field (mExt_Distance), and 3) a speaker virtual angle field (mExt_SpkAngle), which are required to apply the externalization effect when a headphone is used.

FIG. 9 is a diagram of the background sound index field (mBG_index) as the detailed information for the background sound effect. The background sound index field (mBG_index) contains information relating to the background sound added to the audio.

Besides, the present invention can apply other audio effects, and not only the three-dimensional audio effects but also other various audio effects can be adapted to the present invention.

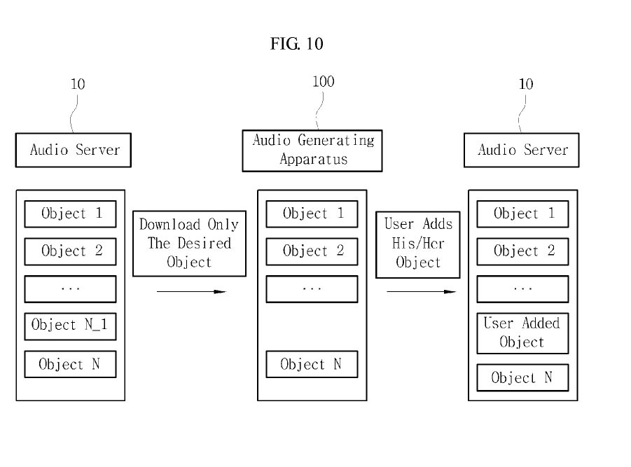

FIG. 10 depicts the audio object selection and addition in an audio file.

The audio file composed of the audio objects used by the audio generating apparatus 100 of FIG. 1 can be downloaded from an audio server 10 connected over a network.

As shown on the left in FIG. 10, the audio generating apparatus 100 can download the audio file including only the audio objects desired by the user, from the audio server 10.

The audio object for the user is allocated to the audio file. That is, the user can add his/her generated audio object to the audio file. Format information of the audio file includes information indicating which audio object is allocated as the audio object for the user.

Based on this format information, the audio generating apparatus 100 can add the audio object generated by the user to the audio file. The audio generating apparatus 100 includes the information indicating which audio object is added by the user, to the format information of the audio file.

The audio generating apparatus 100 can upload the audio file including the audio object added by the user, to the audio server 10. The audio file uploaded to the audio server 10 can be downloaded to another user.

The another user can 1) download only the audio object added by the user who uploads the audio file, or 2) download the audio file including only other audio objects than the added audio object. The another user may 3) download the audio file including both.

The case 1) and the case 2) are practicable by referring to the format information of the audio file.

As set forth above, using the description information including at least one scene effect containing the audio effect to collectively apply to the audio objects, the audio can be generated and reproduced.

The audio can be generated and reproduced using the description information including the object descriptions each containing the information relating the play intervals of the audio objects respectively.

It is possible to store the information to provide the three-dimensional effect per object and to store the encoded information per object. The scene effect information is contained to apply not only the effect per object but also the effect to the entire audio signal. It is possible to set the time to apply the effect. Without having to process a mute interval, the play interval can be defined by splitting one object to several segments.

By use of the scene effect, the effect application time set, and the segment definition, the computations of the object-based audio can be decreased.

The present invention realizes the coadapted audio service based on the user information in the interactive service such as IPTV, improves the existing service by applying to the unidirectional service such as DMB and existing DTV, and contributes to the personalized service realization for the high-quality audio.

The fields used in the audio alone are defined. When the same effect is applied to each object, the effect is applied to the final signal synthesized through the scene effect, rather than applying the same effect to the object individually. Thus, the same result can be acquired with much less computation.

By defining the time information to apply the three-dimensional effect, the present invention can apply the various three-dimensional effects on the time basis with respect to one object.

The present invention can be applied to and realized in not only the audio services such as radio broadcasting, CD and Super Audio CD (SACD) but also the multimedia services via portable devices such as DMB and UCC.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An audio generating method comprising:
generating description information which comprises at least one scene effect containing an audio effect to collectively apply to all of audio objects; and
generating an audio bitstream by combining the description information and the audio objects.

2. The audio generating method of claim 1, wherein the scene effect comprises information indicating an application start time of the audio effect to collectively apply, an application end time of the audio effect to collectively apply, and the audio effect to collectively apply.

3. The audio generating method of claim 1, wherein the description information further comprises object descriptions containing audio effects to apply to the audio objects individually.

4. The audio generating method of claim 3, wherein the object description comprises information indicating an application start time of the audio effect to individually apply, an application end time of the audio effect to individually apply, and the audio effect to individually apply.

5. The audio generating method of claim 1, wherein the description information further comprises object descriptions each containing information relating to play intervals of the audio objects respectively.

6. The audio generating method of claim 5, wherein the play interval comprises a first play interval for the audio object, and a second play start interval apart from the first play interval, and the play interval is defined to reproduce the audio object by segmenting on the time basis.

7. The audio generating method of claim 6, wherein the audio object is not reproduced between the first play interval and the second play interval.

8. The audio generating method of claim 1, wherein the at least one audio effect is determined by an audio editor.

9. The audio generating method of claim 1, wherein the description information contains an ID to distinguish from other description information.

10. An audio generating apparatus comprising:
an encoder for generating description information which comprises at least one scene effect containing an audio effect to collectively apply to all of audio objects; and
a packetizer for generating an audio bitstream by combining the description information and the audio objects.

11. The audio generating apparatus of claim 10, wherein the scene effect comprises information indicating an application start time of the audio effect to collectively apply, an application end time of the audio effect to collectively apply, and the audio effect to collectively apply.

12. The audio generating apparatus of claim 10, wherein the description information further comprises object descriptions containing audio effects to apply to the audio objects individually.

13. The audio generating apparatus of claim 12, wherein the object description comprises information indicating an application start time of the audio effect to individually apply, an application end time of the audio effect to individually apply, and the audio effect to individually apply.

14. The audio generating apparatus of claim 10, wherein the description information further comprises object descriptions each containing information relating to play intervals of the audio objects respectively.

15. The audio generating apparatus of claim 14, wherein the play interval comprises a first play interval for the audio object, and a second play start interval apart from the first play interval, and the play interval is defined to reproduce the audio object by segmenting on the time basis, and the audio object is not reproduced between the first play interval and the second play interval.

16. The audio generating apparatus of claim 10, wherein the at least one audio effect is determined by an audio editor.

17. The audio generating apparatus of claim 10, wherein the description information contains an ID to distinguish from other description information.

18. An audio reproducing method comprising:
separating description information and audio objects in an audio bitstream;
decompressing the audio objects; and
processing audio to collectively apply an audio effect contained in a scene effect of the description information to all of the decompressed audio objects.

19. The audio reproducing method of claim 18, wherein the processing of the audio comprises:
generating one audio signal by combining the decompressed audio objects; and
collectively applying the audio effect to all of the decompressed audio objects by applying the audio effect to the audio signal.

20. The audio reproducing method of claim 19, wherein the processing of the audio further comprises:
before generating the audio signal, applying audio effects to the decompressed audio objects individually by referring to the audio effects contained in object descriptions of the description information.

21. The audio reproducing method of claim 19, wherein the generating of the audio signal generates the one audio signal by synthesizing the decompressed audio objects based on play intervals for the decompressed audio objects in the object descriptions of the description information.

22. The audio reproducing method of claim 21, wherein the play interval comprises a first play interval for the audio object, and a second play start interval apart from the first play interval, and
the generating of the audio signal synthesizes the decompressed audio objects to split and reproduce the audio object on the time basis,
wherein the generating of the audio signal synthesizes the decompressed audio objects not to reproduce the audio object between the first play interval and the second play interval.

23. The audio reproducing method of claim 18, wherein the processing of the audio applies the audio effect to all or some of the decompressed audio objects based on edit of a user.

24. The audio reproducing method of claim 18, wherein the description information contains an ID to distinguish from other description information.

25. An audio reproducing apparatus comprising:
a depacketizer for separating description information and audio objects in an audio bitstream;
an audio decoder for decompressing the audio objects; and
an audio processor for collectively applying an audio effect contained in a scene effect of the description information to all of the decompressed audio objects.

26. The audio reproducing apparatus of claim 25, wherein the audio processor generates one audio signal by combining the decompressed audio object, and collectively applies the audio effect to all of the decompressed audio objects by applying the audio effect to the audio signal.

27. The audio reproducing apparatus of claim 26, wherein the audio processor, before generating the audio signal, applies audio effects to the decompressed audio objects individually by referring to the audio effects contained in object descriptions of the description information.

28. The audio reproducing apparatus of claim 26, wherein the audio processor generates the one audio signal by synthesizing the decompressed audio objects based on play intervals for the decompressed audio objects contained in the object descriptions of the description information,
wherein the play interval comprises a first play interval for the audio object, and a second play start interval apart from the first play interval, and
the audio processor synthesizes the decompressed audio objects to split and reproduce the audio object on the time basis and the decompressed audio objects not to reproduce the audio object between the first play interval and the second play interval.

29. The audio reproducing apparatus of claim 25, wherein the audio processor applies the audio effect to all or some of the decompressed audio objects based on edit of a user.

30. The audio reproducing apparatus of claim 25, wherein the description information contains an ID to distinguish from other description information.
